(19) United States
(12) Patent Application Publication
(10) Pub. No.: US 2026/0205025 A1
(43) Pub. Date: Jul. 16, 2026

(54) SYSTEM AND METHOD FOR PHASE AND LINKED PORTABLE POWER

(71) Applicant: Revolt Holdings Inc., Atlanta, GA (US)

(72) Inventor: James Schwalm, JR., Atlanta, GA (US)

(73) Assignee: Revolt Holdings Inc., Atlanta, GA (US)

(21) Appl. No.: 19/536,082

(22) Filed: Feb. 10, 2026

Related U.S. Application Data
(63) Continuation-in-part of application No. 19/178,477, filed on Apr. 14, 2025.
Application No. 19/178,477 is a continuation of application No. 18/593,026, filed on Mar. 1, 2024, now Pat. No. 12,278,517.
Application No. 18/593,026 is a continuation of application No. 17/496,465, filed on Oct. 7, 2021, now Pat. No. 11,923,722.

(51) Int. Cl. H02M 7/00

(52) U.S. Cl. CPC H02M 7/003

(57) ABSTRACT

Various portable power supply systems, methods and devices are disclosed herein. These systems may comprise a plurality of portable supply units, each portable supply unit comprising: one or more inverters configured to convert a direct-current (DC) power source into a three-phase alternating-current (AC) power output; one or more parallel linking ports; and an interlink cable system connecting the one or more parallel linking ports of the plurality of portable supply units to form a series communication connection between the portable supply units; and a power distribution box configured to receive the three-phase AC power outputs from the plurality of portable supply units and to electrically combine the three-phase AC power outputs to provide a combined three-phase power output.

### RELATED APPLICATION DATA

This application is a continuation-in-part of U.S. application Ser. No. 19/178,477, filed Apr. 14, 2025, which is a continuation of U.S. application Ser. No. 18/593,026, filed Mar. 1, 2024, now U.S. Pat. No. 12,278,517, which is a continuation of U.S. application Ser. No. 17/496,465, filed Oct. 7, 2021, now U.S. Pat. No. 11,923,722, which prior applications are incorporated by reference herein in their entireties.

### FIELD OF THE INVENTION

The present disclosure relates to systems and methods for providing portable power supplies.

### BACKGROUND OF THE INVENTION

Portable power supplies are used to provide power to electric devices at locations where transmission of cabled power is not available from utility companies. However, the portable power supplies have a number of limitations and problems. For example, some portable power supplies use generators which are powered by fossil fuels, contributing to pollution and greenhouse gasses. Some battery-powered supplies have been proposed, but these supplies provide a limited amount of power such that once depleted, the portable power supply must be recharged. Thus, these battery-powered supplies are typically for short term use, such as for a single event, or used as an add-on or back-up power supply.

The use of battery-powered portable power supplies is further limited due to the conventional methods of recharging the portable power supply. For example, once the battery power of a battery-powered portable power supply is depleted, the portable power supply may be transported to a charging station. This method presents several disadvantages. First, the portable power supply must be disconnected from the electrically-powered devices it was previously servicing, thus creating downtime in the use of said electronic devices. Second, the downtime is typically an extended period due to the time for transporting the portable power supply to and from the charging station, and for charging the portable power supply back to full. Third, transporting each portable power supply separately to a charging station creates traffic. Fourth, where a single power station may only service a limited number of mobile power supplies, additional mobile power supplies requiring charging must then wait in line.

As another option, a first depleted battery-powered portable power supply may be replaced or “swapped” with a second charged battery-powered portable power supply to service the same electronically powered devices. However, this “swapping” again necessarily requires disconnecting the electronically-powered devices from the first portable power supply and reconnecting the electronically-powered devices to the second portable power supply. This method of replacement still creates a blackout period when the electronic devices become inoperable. Thus, a more efficient system to provide power to remote locations, and method to provide power in a continuous fashion, are desired.

It is to be understood that some concepts, ideas and problem recognitions provided in this description of the Background may be novel rather than part of the prior art.

### SUMMARY OF THE INVENTION

The disclosure relates to a portable power supply system comprising a plurality of portable supply units. Each portable supply unit includes one or more inverters configured to convert direct-current (DC) power into a three-phase alternating-current (AC) power output and one or more parallel linking ports. The parallel linking ports of the plurality of portable supply units are connected by an interlink cable system that forms a series communication connection between the portable supply units. The system further includes a power distribution box configured to receive the three-phase AC power outputs from the plurality of portable supply units and to electrically combine the three-phase AC power outputs to provide a combined three-phase power output. In certain embodiments, each three-phase AC power output comprises an approximately 208-volt three-phase AC output, and the three-phase AC power outputs are provided to the power distribution box through a multiple cable connector system. The interlink cable system may be configured to interconnect up to six portable supply units. The interlink cable system is configured to transmit digital communication signals between the plurality of portable supply units. The digital communication signals are used to synchronize the three-phase AC power outputs generated by the inverters of the plurality of portable supply units.

The disclosure further relates to a method of parallel linking a plurality of portable supply units. The method includes connecting parallel linking ports of the plurality of portable supply units using an interlink cable system to form a series communication connection between the portable supply units and electrically connecting three-phase AC power outputs from each of the plurality of portable supply units in parallel. The method further includes designating one of the plurality of portable supply units as a master unit and designating remaining portable supply units as one or more interlinked units, transmitting digital communication signals from the master unit to the one or more interlinked units through the interlink cable system, synchronizing the three-phase AC power outputs of the plurality of portable supply units based on the digital communication signals, and providing a combined three-phase AC power output based on the synchronized three-phase AC power outputs. In certain embodiments of the method, DC power is supplied to at least one inverter of each portable supply unit and converted by the inverter into the three-phase AC power output. The method may further include receiving the three-phase AC power outputs from each of the plurality of portable supply units by a power distribution box and electrically combining the received three-phase AC power outputs to provide the combined three-phase AC power output. Designating one of the plurality of portable supply units as the master unit may comprise selecting a master position using a parallel link key of the portable supply unit. Synchronizing the three-phase AC power outputs may comprise synchronizing phase angles of each phase leg and synchronizing waveform timing such that sine waves produced by the inverters are aligned. The method may further include energizing one or more interlinked units automatically in response to activation of the master unit.

The disclosure also relates to a portable power supply unit comprising a direct-current (DC) power supply, one or more inverters electrically coupled to the DC power supply and configured to generate a three-phase alternating-current (AC) power output, a three-phase power output interface configured to deliver the three-phase AC power output, and one or more parallel linking ports configured to exchange digital communication signals with at least one additional portable power supply unit. The portable power supply unit is configured to provide the three-phase AC power output based on the digital communication signals.

### DESCRIPTION OF THE DRAWINGS

The present disclosure may be better understood by reference to the following detailed description taken in conjunction with the accompanying drawings, which illustrate particular embodiments in accordance with the present disclosure of invention.

FIG. 1 illustrates an exemplary portable supply unit.

FIG. 2 illustrates the main components of the preferred embodiment of a portable power supply system with a plurality of portable supply units.

FIG. 3 illustrates a preferred embodiment of the power-related components in a portable supply unit and a canavan.

FIG. 4A illustrates a side perspective view of a portable supply unit, in accordance with various embodiments.

FIG. 4B illustrates a front view of a portable supply unit, in accordance with various embodiments.

FIG. 5 illustrates a preferred embodiment of a parallel linking of one or more portable supply units.

FIG. 6 illustrates a preferred embodiment of three-phase power output system of one or more portable supply units.

### DETAILED DESCRIPTION OF THE INVENTION

Reference will now be made in detail to some specific embodiments in accordance with the present disclosure of invention. While the present disclosure is described in conjunction with these specific embodiments, it is not intended to limit the teachings of the present disclosure to the described embodiments. On the contrary, it is intended to cover alternatives, modifications, and equivalents as may be included within the spirit and scope of the teachings of the present disclosure.

In the following description, numerous specific details are set to provide a thorough understanding of the present disclosure. Particular embodiments may be implemented without some or all of these specific details. In other instances, well known process operations have not been described in detail in order not to unnecessarily obscure the present disclosure of invention.

Aspects of the invention comprise portable and re-chargeable power supplies, a system for providing portable power, and methods for providing portable power and re-charging portable power supplies.

One embodiment of a portable power supply system of the present invention may include three main components. First, a portable and re-chargeable power supply unit, which may be transported to a desired remote location (such as a location where a continuous power supply is not available) and used to supply electrical power to one or more electrical devices (devices that are powered by or require electrical power) at the remote location. Second, a portable power charging unit (“canavan”), which may be transported to the remote location of a portable supply unit and used to recharge the power supply of the portable supply unit. Third, a central charging and monitoring system or station which may include one or more charging stations used to charge the one or more canavans, and at least one control device or station used to monitor and manage the efficient charging of the canavans and portable supply units.

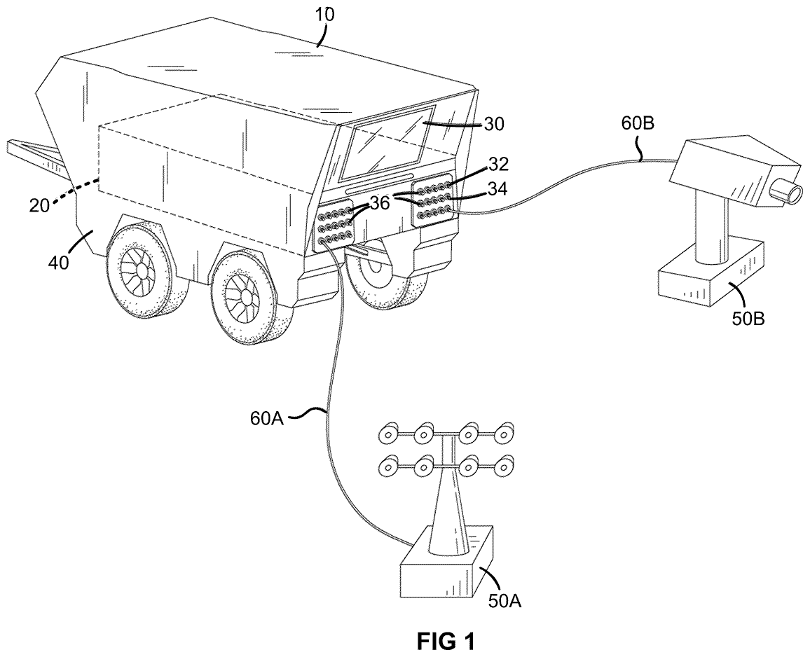

FIG. 1 illustrates an exemplary portable supply unit 10. As indicated, the portable supply unit 10 is preferably portable. In one embodiment, the portable supply unit 10 comprises a power supply, and preferably a re-chargeable power supply in the form of one or more batteries or a unit battery 20. In order to render the portable power supply portable or transportable, the portable power supply may be part of or associated with a vehicle or otherwise be readily movable. In a preferred embodiment, the portable supply unit 10 is not self-propelled, but is configured to be moved by another powered vehicle. As such, the portable supply unit 10 may comprise a trailer 40 or other wheeled support. The one or more batteries 20 and other components of the portable supply unit 10, such a control panel 30, may be associated with the trailer, such as by being supported on a supporting surface thereof or by being mounted to a frame or other support structure thereof. The trailer 40 or other transportable support might be open or enclosed, such as to form an enclosure which internally houses one or more components of the portable supply unit 10.

In one embodiment, the one or more batteries 20 comprise one or more electrical power storage units, such as a plurality of batteries. The one or more batteries 20 may be of one or more types, such as lead-acid, nickel-cadmium (NiCd), nickel-metal hydride (NiMH), lithium-ion (Li-ion), lithium-ion phosphate, lithium-ion polymer (LiPo) or other types now known or later developed. In one embodiment, the at least one unit battery 20 is rechargeable and can provide a DC output at a charge differential of 800V. In one embodiment, the unit battery 20 may be an 80V DC lithium ion phosphate battery.

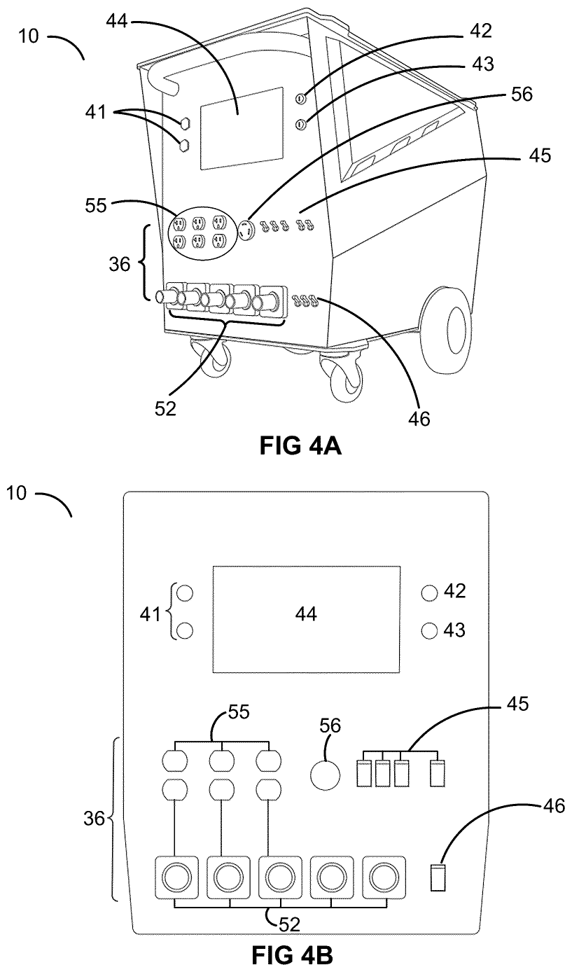

As indicated, the portable supply unit 10 may comprise a control panel 30. The control panel 30 may include one or more of the following components: a control interface 32, a battery monitor system 34, and a plurality of power supply sockets or ports 36. Electrically-powered devices 50 may be connected to the power supply sockets or ports 36, such as via electric cables 60 having mating plugs. The sockets or ports 36 may comprise, for example, electrical sockets of the type used to provide 110, 208 or 220V AC electrical power, or any AC voltage between 110 to 250-volt AC, and might have various configurations, such as standard Type A thru Type O sockets, and be configured to receive two or three pins or blade plugs, etc. The ports 36 are described in further detail with reference to FIGS. 4A and 4B.

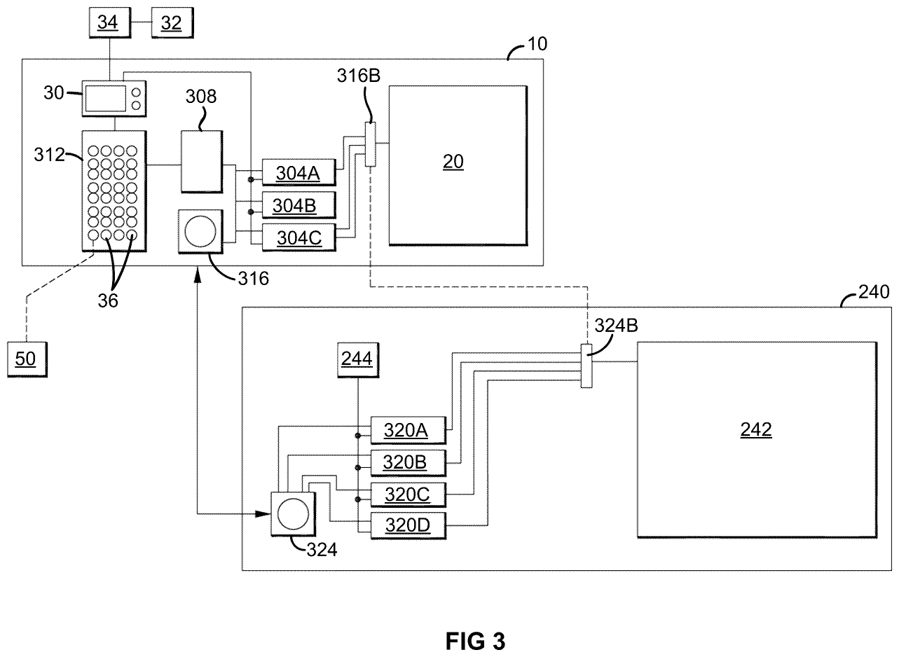

Additional components of the portable supply unit 10 are discussed below and illustrated in FIG. 3.

The control interface 32 may be used to control the flow of power from the at least one unit battery 20 to the power supply sockets or ports 36 (and thus to the electrically-powered devices connected thereto). Such control may include one or more switches or the like, such as for turning the power supply on or off, or to provide a desired power output, for each specific socket or all sockets at once.

The battery monitor system 34 is configured to monitor the amount of power remaining in the at least one unit battery 20, and the power usage through the power supply sockets or ports 36. The monitor system 34 may be configured to use information regarding the amount of power and the power usage to, for example, provide an output of the remaining time until the at least one unit battery 20 will be depleted (at least to a point below a current or desired load level) and require recharging. The monitored information may also be displayed on a display device (such as a video display) on the exterior of the portable supply unit 10.

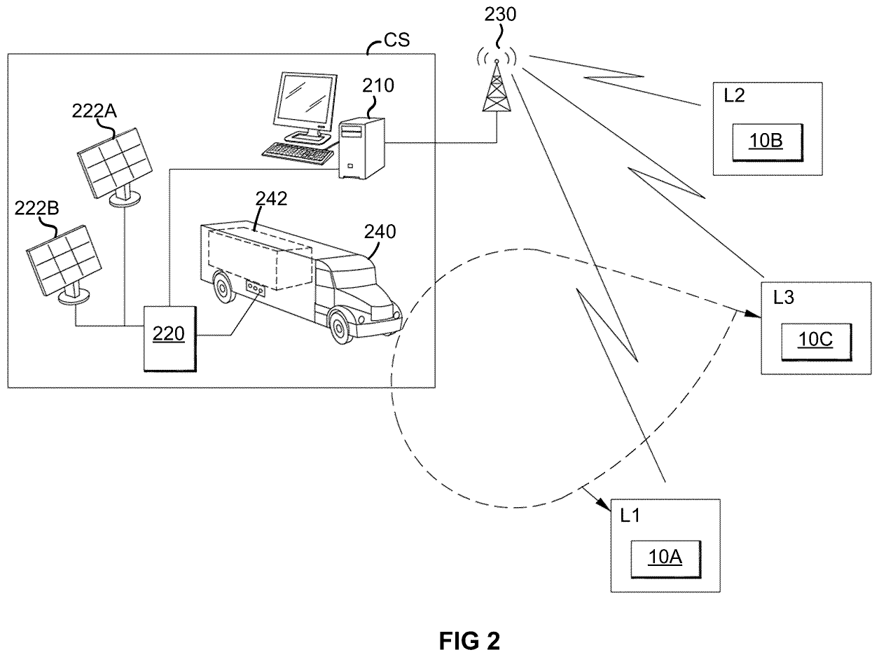

In one embodiment, the monitor system 34 preferably includes a communication interface. In one embodiment, the communication interface may comprise a wireless communication interface, such as for transmitting and receiving information over a cellular, radio or other network. In one embodiment, information received by or generated by the monitor system 34 may be transmitted to the central charging and monitoring system (discussed below and illustrated in FIG. 2). For example, the battery monitor system 34 may also be configured to transmit information regarding the current charge status of the at least one unit battery 20, the power usage, and/or to automatically and/or manually configured to alert the central charging system when the amount of power drops below a predetermined value or when the amount of calculated remaining time until battery discharge reaches a predetermined amount of time.

In one embodiment, the control interface 32 and/or monitor system 34 may comprise at least one controller. The controller may be hardwired, or might comprise a general processor which is configured to execute machine-readable code (e.g. “software”) which is stored in a memory device. For example, the controller may, based upon execution of the software, be configured to receive information regarding a remaining charge of the at least one unit battery 20 and the rate of power consumption, such as to generate a time to discharge (e.g. an estimated time until the at least one unit battery 20 will have insufficient power to meet the load).

It is contemplated that the various components of the control interface 32, monitor system 34, and 36 may be located at separate locations on the portable supply unit 10. The power supply sockets or ports 36 may also be located on more than one sides of the portable supply unit 10 to provide easy access to electronic devices at various locations. In another embodiment, the portable supply unit 10 may be configured to provide wireless charging.

The portable supply unit 10 may include other features. For example, the one or more batteries 20 may be located in an enclosure. The enclosure may be configured with ventilation ports and/or cooling features such as fans or the like, in order to reduce the temperature of the batteries 20. In one embodiment, thermometers may be used to gather information regarding the temperature of the air around the batteries 20 and/or the batteries themselves. This information may be provide to the monitor system 34. In one embodiment, the monitor system 34 might reduce the supplied power, provide alerts or the like, in the event of a thermal overload. In one embodiment, said other features may be powered using a separate power source, such as a secondary battery, to ensure a minimum level of power supply to the electrically-powered devices 50.

FIG. 2 illustrates one embodiment of a portable power supply system in accordance with the invention. In one embodiment, the system includes one or more portable supply units 10. As indicated, the portable supply units 10 may be located at one or more remote locations (such as locations L1, L2, L3) at which power is required. The one or more portable supply units 10 may be transported to and parked at each remote location, such as by connecting the trailer 40 thereof to a tow vehicle, such as a truck, transporting the portable supply unit 10 to the remote location and then dropping it off at that location (where upon the truck may be used to transport other portable supply units 10). It will be appreciated that one portable supply unit 10 or more than one might be used at a single location.

The system also comprises a central charging and monitoring station CS. The central charging and monitoring station CS may be located remotely from the remote locations. For example, the central charging and monitoring station CS might be located in a city, while the remote locations might be located remote from the central charging and monitoring station CS, such as outside of the city where a dedicated power supply is not available.

In one embodiment, the central charging and monitoring station CS is in communication with the portable supply units 10 via a communication interface. This interface may support wireless communications 230 with or between the station CS and the portable supply units 10, such as via one or more networks (LANs, WANs, the Internet, a cellular and/or radio communication system, etc., where such networks may include one or more wired communication links).

The central charging sand monitoring station CS may include one or more control devices 210 and one or more charging stations 220. As described in more detail below, the one or more charging stations 220 may be used to charge one or more recharging devices, or canavans 240, that may be used to re-charge the portable supply units 10 at the remote locations L1, L2, L3. In a preferred embodiment, when a portable supply unit 10 is not in use at a remote location, it may be transported back to the central charging and monitoring station CS for storage and direct re-charging, such as via connection to one of the charging stations 220. In this manner, when a portable supply unit 10 is delivered to a remote location L1, L2, L3, etc., it can be fully charged for use.

The control device 210 may include at least one server, which may include one or more processors or controllers, at least one communication device or interface, a database or other data storage device, and one or more additional memory or data storage devices (which may be separate from the database). In one or more embodiments, the processor(s) is configured to execute one or more instructions, such as in the form of machine-readable code (i.e. “software”), to allow the server to perform various functions. The software is preferably non-transitory, such as by being fixed in a tangible medium. For example, the software may be stored in the one or more memory devices. One or more of the memory devices may be read-only. In addition, the software may be stored on a removable medium in some embodiments. In general, the one or more memory devices are used as temporary storage. For example, the one or more memory devices may be random access memory or cache memory used to temporarily store some user information and/or instructions for execution by the at least one processor.

The charging stations 220 preferably comprise stations which are connected to a power supply and can provide power to a portable power device, such as via a cable connected to a socket of the charging station 220 and the portable power device. In a preferred embodiment, the power supply for the charging station 220 comprises a renewable energy source, such as one or more solar panels 222 (and associated power storage devices, etc.), but might comprise other power sources (such as via an electrical utility, etc.). The charging station 220 is configured to provide recharging power to a portable power device, e.g. a canavan 240 (or as described above, in certain instances, a portable supply unit 10). The canavan 240 preferably comprises a mobile unit which has a power storage element, such as one or more canavan batteries 242 (discussed below and illustrated in FIG. 3). In one embodiment, the canavan 240 is self-powered, such as comprising a motorized vehicle such as a van, truck or the like, which can be driven (by a driver or autonomously) from the central charging and monitoring station CS to the one or more remote locations L1, L2, L3, etc. However, the canavan 240 might comprise other types of vehicles or the like, for transporting the one or more batteries 242.

As indicated, the canavans 240 include one or more power sources, such as at least one rechargeable battery 242. As described in more detail below, the at least one battery 242 may be charged at one of the charging stations 220 at the central charging and monitoring station 220 and then be transported to a remote location L1, L2, L3, etc., where the at least one battery 242 may preferably be used to: 1) re-charge the at least one unit battery 20 of the portable supply units 10 at the one or more remote locations and 2) supply power to the electrically-powered components that are connected to the portable supply units 10, during the portable supply unit re-charging process. In one embodiment, the canavan 240 is configured to transport additional unit batteries 20 or portable supply units 10 to remote location L1, L2, L3, etc. to provide backup power sources during or after charging.

Once again, the at least one canavan battery 242 may be of various types and configurations. In one embodiment, the at least one canavan battery 242 is configured to provide an amount of power which exceeds the maximum amount of power that can be supplied by an individual portable supply unit 10. For example, the batteries 20 of a portable supply unit 10 may be configured to provide 120 kWH of power, while the canavan batteries 242 may be configured to provide a multiple thereof, such as 6-10 times as much power (such as 1200 kWH of power).

As with the portable supply unit 10, the canavan 240 may include additional components. For example, as illustrated in FIG. 3, the canavan 240 may include a controller 244, such as for monitoring the power level of the at least one canavan battery 242, for controlling one or more switches, etc.

Additional components of the canavan 240 are discussed below and illustrated in FIG. 3.

In a preferred embodiment, the portable supply units 10 may be in communication with the control device 210 (such as via the battery monitor systems 34). Upon determining and/or anticipation the amount of power in the unit battery 20 falling below a predetermined number (which may be based on current amount and/or usage), a charge order may be created to direct a canavan 240 to the portable supply units 10.

In one embodiment, users may manually alert the control device 210 and/or to place a charge order. Such manual alerts may be achieved via the control interface 32 or software applications running on user devices such as smartphones, personal computers, etc.

In a preferred embodiment, the at least one canavan battery 242 holds enough power to charge more than one portable supply unit 10 from empty to full. Where outstanding charge orders exist for portable supply units 10 at more than one location L1, L2, L3, etc., the control device 210 may be configured to determine an optimal charging sequence, such as based upon a distance from the central charging and monitoring station CS to the one or more remote locations L1, L2, L3, the distance from one remote location to another, and the amount of power needed to recharge the one or more portable supply units 10, etc. For example, where portable supply units 10A and 10B both require charging, the control device 210 may determine portable supply unit 10A at location L1 has a lower amount of power remaining, and the canavan 240 may be instructed to drive to location L1 to charge portable supply unit 10A first. Further, the control device 210 may determine routing based upon an optimization of the number of portable supply units 10 that the canavan 240 can re-charge in a single delivery route. In one embodiment, the control device 210 may also be configured to determine an optional route for driving the canavan 240 to more than one location based on traffic and/or time travelled. Additionally, where more than one canavan 240 is needed, the control device 210 may be configured to determine the optimal sequence of charging and/or route for each canavan 240. As indicated, a driver may drive the canavan 240 to the one or more locations, including under the guidance of a route generated by the control device 210.

In one embodiment, the control device 210 may be configured to respond to additional requests from remote location L1, L2, L3, etc., such as reports for defective portable supply units 10 or request for additional portable supply units 10. In response, the control device 210 may create separate or additional charge orders for or delivery of additional batteries 20 or portable supply units 10, which may be achieved with canavans 240 or other transportation devices used to transport portable supply units 10.

FIG. 3 illustrates a preferred embodiment of the power-related components of a portable supply unit 10 and a canavan 240. As illustrated in FIG. 3, a portable supply unit 10 may include at least one or more of the following power-related components: the one or more batteries 20, one or more power inverters 304, one or more transformers 308, a power output 312, and a master charging port 316. As illustrated and discussed in more detail above, the portable supply unit 10 may include additional components such as the monitor system 34 (such as for monitoring the power level of the at least one unit battery 20 and for controlling one or more output switches, etc.), and the control panel 30 and control interface 32.

In a one embodiment, the unit 10 may be a large energy converter, such as a canavan. The at least one unit battery 20 may provide a power supply of 800 V-DC and have 120 KWH capacity. The battery 20 may be electrically connected to the one or more inverters 304. In a one embodiment, there may be at least three inverters 304, each configured to convert 800 V-DC to 480 V-AC. The inverters 304 may be connected to both the transformer 308 and the charging port 316. In a preferred embodiment, the transformer 308 may be configured to reduce the power output voltage from 480 V-AC to 208 V-AC, or other desire voltage. The transformer 308 may be connected to the power output 312, which may contain one or more power supply ports 36 (as discussed above and illustrated in FIG. 1). In a preferred embodiment, the power output 312 may be configured to output power at 208 V-AC.

In a preferred embodiment, the unit 10 may be a portable electrical supply unit comprising at least one inverter 304 configured to convert a DC voltage to AC output. The at least one unit battery 20 may be configured to provide an approximately 80 V-DC power supply, and have an energy capacity of about 17.5 maximum kWh. The battery 20 may be electrically connected to the one or more inverters 304. Alternatively, in various embodiments, the one or more inverters 304 may be connected to the charging port 316, wherein the inverter 304 may receive a V-DC power supply and convert to an AC output. In a one embodiment, the unit 10 may include three inverters 304, each configured to convert a DC input voltage to a 120 V-AC output corresponding to a respective phase leg. Collectively the inverters 304 produces a 208 V three-phase AC power supply, with each phase leg providing approximately 120 V-AC. The three-phase AC output may be provided through one or more power outputs 312, including a multiple cable connector system such as a three-phase cam-lock connector assembly or a suitable connector wherein a separate cable is configured to transfer a each phase of a three-phase AC power output.

The charging port 316 may be used to charge the at least one unit battery 20, as described below, and provide a pathway of power therefrom to the power output 312.

The canavan 240 may include at least one or more of the following power-related components: the at least one canavan battery 242, one or more canavan inverters 320, and a master canavan charging port 324. In a preferred embodiment, the at least one canavan battery 242 may provide a power supply of 800 V-DC and have 1000 to 2000 kWH capacity. The canavan battery 242 may be electronically connected to the canavan inverters 320. In a preferred embodiment, there may be at least four canavan inverters 320, each may be configured to convert 800 V-DC 480 V-AC. The outputs of the canavan inverters 320 are connected to the canavan charging port 324.

Most importantly, the master canavan charging port 324 can be connected to the master charging port 316, such as via one or more cables. As described below, this allows the at least one canavan battery 242 to preferably: 1) charge the one or more unit batteries 20 and 2) supply required power to the electrical devices or components which are connected to the power output 312 of the portable supply unit 10.

In particular, upon connecting the master charging port 316 to the master canavan charging port 324, the electrical output of one or more of the canavan inverters 320A, 320B, 320C is preferably placed in communication with the transformer 308 of the portable supply unit 10, such that 480 V-AC power is provided by the canavan 240 to the transformer 308 of the portable supply unit 10, and thereon (at preferably 208 V-AC) to the power output 312. In this manner, the canavan 240 provides the power required to power any electrical devices which are connected to the portable supply unit 10 during the recharging process. At the same time, the 480 V-AC output from the canavan 240, such as via one of the inverters 320D thereof, is placed in communication with at least one of the inverters 304 such that the AC power which is output from the canavan 240 is converted to DC and is used to charge the one or more distribution batteries 20.

In another embodiment, the portable supply unit 10 and/or canavan 240 may include other or additional master charging ports, such as two or more ports. As one example, the unit battery 20 may include a secondary charging port 316B, such as a DC charging port, and the canavan battery 242 may include a secondary charging port 324B, such as a DC charging port, allowing power to be directly transmitted from the canavan battery 242 for charging the unit battery 20 (such as, in a preferred embodiment, at 800 V-DC), while the canavan 240 also supplies an AC output to the portable supply unit 10 (such as to the transformer 308 thereof) for continuing to power the electrical devices which are connected to the power output 312 of the portable supply unit 10, via the connection of the master canavan port 324 to the master distribution port 316.

The improved charging method using a canavan inverter 320D to temporarily serve as the new power source to the power output 312 may permit the portable supply unit 10 to continue to output power to any connected electronic devices 50 while charging. This configuration ensures continuous power output which allows the electronic devices to operate without downtime, which is desirable or necessary in many scenarios. For example, a preferred use of the portable supply unit 10 may be for movie sets used in filming at remote locations, where the electronic devices 50 may include a plurality of lighting kits 50A, cameras 50B or the like, each requiring a source power. Continuous filming may be necessary, such that lighting kits must operate with no downtime. Movie staff may also require continuous power to maintain the operation of various electronic devices in their living quarters. The improved mobile power system and charging method may also be used in other remote-location activities such as mining, archaeology, construction, etc.

The canavan 240 has been described as having one or more inverters 320 for converting DC power to AC power. Further, the canavan 240 may be charged, such as by connecting the master canavan charging port 324 to a charging station 220, whereupon an AC power supply may be provided to the canavan 240 and may be converted to DC power (via the one or more inverters 320) for charging the at least one canavan battery 242. Of course, the canavan 240 might include one or more inverters for converting DC power from the battery to an AC output, and another one or more inventors for converting supplied AC power from the charging station 220 to DC power for charging the at least one canavan battery 242. In other embodiments, the charging station 220 might be configured to output DC power which can be used to charge the at least one canavan battery 242 directly (e.g., without use of an inverter).

Likewise, the portable supply unit 10 might include separate inverters for converting DC power from the one or more batteries 20 thereof to AC, and for converting supplied AC power to DC for charging the one or more batteries 20 thereof.

In one embodiment, the portable supply unit 10 and canavan 240 each have one or more batteries that provide 800V power. However, in other embodiments, particularly when DC to DC charging (of the portable supply unit 10 via the canavan 240) is employed, it may be desirable for the voltages to differ, preferably by having the battery voltage of the canavan 240 higher than that of the portable supply units 10.

FIGS. 4A and 4B illustrate a portable supply unit 10 in accordance with various embodiments.

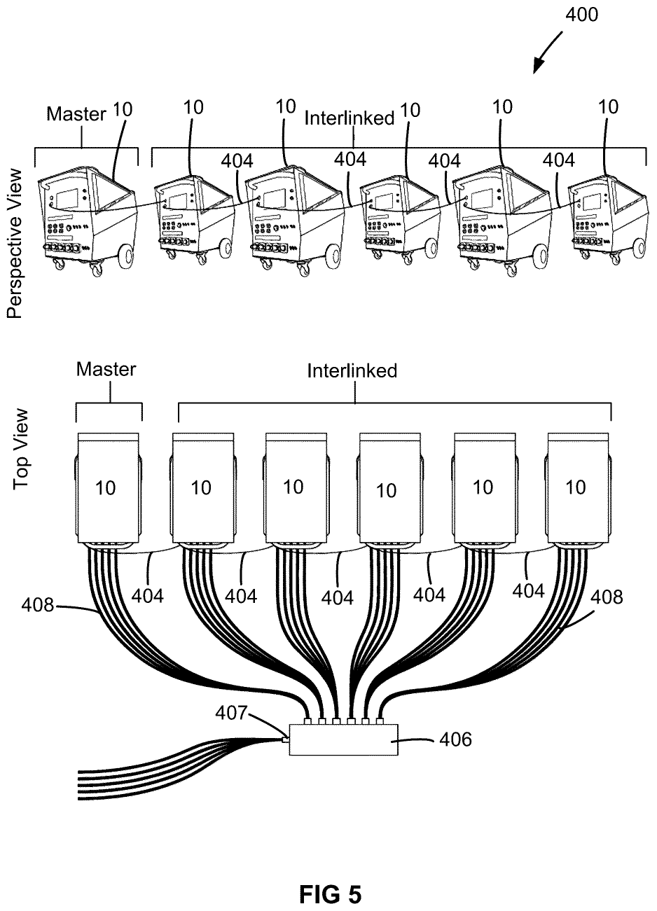

The portable supply unit 10 may comprise parallel linking ports 41, also referred to as parallel link ports. The parallel linking ports 41 may be configured to interconnect multiple portable supply units 10 using an interlink cable system 404, as described in more detail with reference to FIG. 5. The parallel linking ports 41 may be digital communication ports and may comprise M12-type connectors or other suitable industrial communication connectors. In one embodiment, each unit 10 includes a first and second parallel linking port, wherein the first parallel linking port is a data communications output port and the second parallel linking port is a data communications input port.

The portable supply unit 10 may further comprise a power mode key 42 and a parallel link key 43. Each key may be a mechanical or electrical selector configured to allow a user to select various operating modes and power modes of the unit 10. The power mode key 42 and parallel link key 43 may be a selection device for a user to select various modes of the power and parallel link system. In some embodiments, the power mode key 42 and parallel link key 43 may be configured to receive a key, which may be rotated to make a selection.

In various embodiments, the power mode key 42 may comprise an OFF position, CHARGE position, and ON/CHARGE position. The OFF position is configured to disable to power input and output from the unit 10. The CHARGE position allows the unit 10 to receive a charging input, while disabling the power output. The ON/CHARGE positions allows the unit 10 to both receive a charging input and simultaneously output a power supply. The ON/CHARGE position allows the unit 10 to receive a DC input and output the three-phase AC output.

In various embodiments, the parallel link key 43 may include a MASTER position, an INTERLINKED position, and an END LINK position. The unit 10 may be placed in different parallel link modes based on the desired use of the parallel linking system 400. In the MASTER position, the unit 10 is configured to operate as a stand alone unit or as a controlling unit to transmit digital control and synchronization signals to other interconnected units. In the INTERLINKED position, the unit 10 is configured to receive digital control and synchronization signals from an upstream unit. In the END LINK position, the unit 10 is configured to terminate the communication to other units and disable parallel power output. It can be appreciated that in various embodiments, the user can control the parallel link mode of the unit 10 by selection through a user interface such as display 44.

The portable supply unit 10 may comprise one or more power ports 36, configured to provide AC power outputs. The ports 36 may include the power outputs 312 as described with reference to FIGS. 1-3. The ports 36 may include AC main outputs 55, such as a 120 V-AC outlet. The ports 36 may further include a single-phase output 56, such as a 208 V two-line single-phase AC output.

The ports 36 may further comprise a three-phase power output 52. For example, the three-phase power output 52 may comprise a multiple cable connector system including three phase terminals (L1, L2, L3), a neutral terminals, and a ground terminals. In various embodiments, the three-phase power output 52 may comprise cam-lock connectors.

The unit 10 may include a system breaker 46 configured to selectively disconnect the output of all ports 36. The unit 10 may further include one or more auxiliary breakers 45 configured to independently disconnect selected outputs, including the AC main outputs 55 and/or the single-phase output 56.

FIG. 5 illustrates an embodiment of a parallel linking configuration for one or more portable supply units 10, in accordance with various embodiments. The parallel linking system 400 may comprise one or more portable supply units 10 linked or interconnected through an interlink cable system 404. The interlink cable system 404 may be connected to the parallel linking ports 41 of the units 10 and is configured to transmit digital communication signals for coordination and synchronization of the units 10. In various embodiments, the interlink cable system 404 may be configured to connect up to six portable supply units 10, wherein the units are coupled in a series communication via the interlink cable system 404 and the three-phase AC power outputs electrically connected in parallel.

The three-phase power output 52 of each portable supply unit 10 may be connected to respective power cables 408, which are provided to power box 406. In one embodiment, the power box 406 may be a spider box or other suitable power distribution unit. The power box 406 may be configured to receive the three-phase AC outputs from each of the connected units 10 and provide a combined three-phase output 407. In one embodiment, each portable supply unit 10 provides approximately 30 amperes per phase leg at 208-V three-phase AC, such that each additional interconnected unit proportionally increases the total available output current per phase.

As discussed with reference to FIGS. 4A and 4B, the parallel link key 43 may be used to select the operation mode. The parallel linking system 400 may comprise one unit 10 selected to operate in a MASTER mode and one or more additional units 10 to operate in INTERLINKED mode. A unit 10 designated in the MASTER position operates as a master unit, while units designated in the INTERLINKED position operate as downstream units under control of the master unit.

In various embodiments, a user may designate one portable supply unit 10 as the master unit by selecting the MASTER position on the parallel link key 43, while designating one or more additional units as downstream units by selecting the INTERLINKED position. The master unit is configured to transmit digital control and synchronization signals to the downstream units through the interlink cable system 404.

In various embodiments, each unit 10 may receive communications for synchronization from the proximate upstream unit, and send communications from the proximate downstream unit, wherein proximate means connected via the interlink cable system 404.

In various embodiments, each portable supply unit 10 may comprise a controller configured to determine the selection of the parallel link key 43 and adjust the operation of the unit and communications.

When the parallel link key 43 of a portable supply unit 10 is set to the master position, that portable supply unit 10 becomes the master unit for all subsequently interconnected portable supply units 10. The downstream portable supply units 10, connected through the interlink cable system 404 with interlinked mode selected, wherein operational control is transferred to the master unit 10.

Upon activation of the master unit 10, the master unit 10 may be configured to activate or energize the downstream units 10. For example, upon activation of the master portable supply unit 10, all interconnected downstream portable supply units 10 may power on simultaneously. This master-controlled configuration maintains synchronization of phase angles and waveform timing across all three phase legs of the interconnected system.

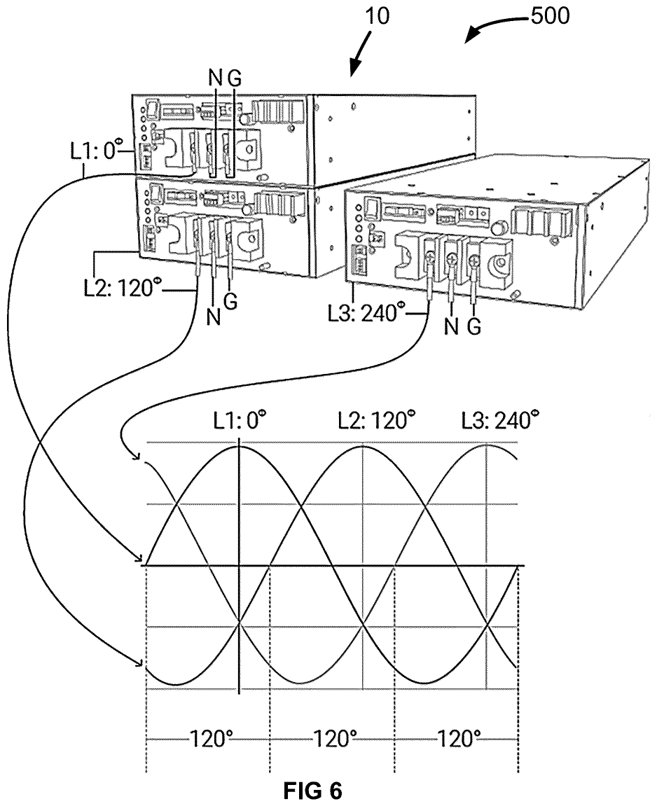

FIG. 6 illustrates an exemplary three-phase power output system 500 of a unit 10, in accordance with various embodiments. The three-phase linking system 500 may be configured to provide power to the three-phase power output 52. The three-phase linking system 500 may comprise three separate inverters for converting DC input to an AC single phase output. The three-phase linking system 500 provides three-phase AC output, L1 (0 degree phase shift), L2 (120 degree phase shift) and L3 (240 degree phase shift).

In various embodiments, each portable supply unit 10 converts a DC input to a three-phase AC output using three inverters. For example, an approximately 80-V DC input supplied by the unit battery 20 may be converted to three 120-V AC phase outputs, collectively forming a 208-V three-phase AC power supply. When multiple portable supply units 10 are interconnected through the interlink cable system 404, digital communication transmitted between the units synchronizes the phase angles and sine wave timing of the inverter assemblies. This synchronization enables parallel operation of the three-phase AC outputs through the multiple cable connector system without phase conflict or destructive interference.

Although many of the components and processes are described above in the singular for convenience, it will be appreciated by one of skill in the art that multiple components and repeated processes can also be used to practice the techniques of the present disclosure. As used herein, the term “and/or” implies all possible combinations. In other words, A and/or B covers, A alone, B alone, and A and B together.

While the present disclosure of invention has been particularly shown and described with reference to specific embodiments thereof, it will be understood by those skilled in the art that changes in the form and details of the disclosed embodiments may be made without departing from the spirit or scope of the present teachings. It is therefore intended that the disclosure be interpreted to include all variations and equivalents that fall within the true spirit and scope of the present teachings.

What is claimed is:

1. A portable power supply system comprising:
a plurality of portable supply units, each portable supply unit comprising:
one or more inverters configured to convert a direct-current (DC) power source into a three-phase alternating-current (AC) power output;
one or more parallel linking ports; and
an interlink cable system connecting the one or more parallel linking ports of the plurality of portable supply units to form a series communication connection between the portable supply units; and
a power distribution box configured to receive the three-phase AC power outputs from the plurality of portable supply units and to electrically combine the three-phase AC power outputs to provide a combined three-phase power output.

2. The system of claim 1, wherein each of the three-phase AC power outputs comprises an approximately 208-volt three-phase AC output.

3. The system of claim 1, wherein each of the three-phase AC power outputs are provided to the power distribution box through a multi cable connector system.

4. The system of claim 1, wherein each of the portable supply units comprises a parallel link key configured to select an operating mode of the portable supply units.

5. The system of claim 1, wherein at least one of the portable supply units comprises a unit battery, and wherein the DC power source supplied to the one or more inverters is provided by the unit battery.

6. The system of claim 1, wherein the interlink cable system is configured to interconnect up to six portable supply units.

7. The system of claim 1, wherein the interlink cable system is configured to transmit digital communication signals that synchronize the three-phase AC power outputs generated by the one or more inverters of the plurality of portable supply units.

8. A method of parallel linking a plurality of portable supply units, the method comprising:
connecting parallel linking ports of the plurality of portable supply units using an interlink cable system to form a series communication connection between the portable supply units,
electrically connecting a three-phase AC power outputs from each of the plurality of portable supply units in parallel;
designating one of the plurality of portable supply units as a master unit and designating remaining portable supply units as one or more interlinked units;
transmitting digital communication signals from the master unit to the one or more interlinked units through the interlink cable system;
synchronizing the three-phase AC power outputs of each of the plurality of portable supply units, based on the digital communication signals; and
providing a combined three-phase AC power output, based on the synchronized three-phase AC power outputs of each of the portable supply units.

9. The method of claim 8, further comprising:
supplying DC power to at least one inverter of each portable supply unit; and
converting, by the at least one inverter, the DC power source into the three-phase AC power output.

10. The method of claim 8, further comprising:
receiving, by a power distribution box, the three-phase AC power outputs from each of the plurality of portable supply units; and
electrically combining, by the power distribution box, the received three-phase AC power outputs to provide the combined three-phase AC power output.

11. The method of claim 8, wherein designating one of the plurality of portable supply units as the master unit comprises selecting a master position using a parallel link key of the portable supply unit.

12. The method of claim 8, wherein synchronizing the three-phase AC power outputs comprises synchronizing phase angles of each phase leg of the three-phase AC power outputs across the plurality of portable supply units.

13. The method of claim 8, wherein synchronizing the three-phase AC power outputs comprises synchronizing waveform timing such that sine waves produced by inverters of the plurality of portable supply units are aligned.

14. The method of claim 8, further comprising energizing the one or more interlinked units automatically in response to activation of the master unit.

15. A portable power supply unit comprising:
a direct-current (DC) power source;
one or more inverters electrically coupled to the DC power source, the one or more inverters configured to generate a three-phase alternating-current (AC) power output;
a three-phase power output interface configured to deliver the three-phase AC power output;
one or more parallel linking ports configured to exchange digital communication signals with the at least one additional portable power supply unit; and
wherein the portable power supply unit provides the three-phase AC power output based on the digital communication signals.

16. The portable power supply unit of claim 15, wherein the DC power source comprises a unit battery.

17. The portable power supply unit of claim 15, wherein the one or more inverters are configured to generate approximately 120 volts AC per phase leg, collectively forming an approximately 208-volt three-phase AC output.

18. The portable power supply unit of claim 15, wherein the one or more parallel linking ports are configured to form part of a series communication chain with the at least one additional portable power supply units.

19. The portable power supply unit of claim 15, further comprising a parallel link key configured to operate the portable power supply unit in a master mode or an interlinked mode based on a position of the parallel link key.

20. The portable power supply unit of claim 19, wherein, when operated in the master mode, the portable supply unit is configured to transmit synchronization data to one or more additional portable power supply devices.
